(19) United States
(12) Patent Application Publication
(10) Pub. No.: US 2005/0203802 A1
(43) Pub. Date: Sep. 15, 2005

(54) Sales management system for point service, sales management method, and program

(75) Inventors: Kei Suzuki, Kanagawa (JP); Hidetoshi Sato, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC Infrontia Corporation

(21) Appl. No.: 11/074,794

(22) Filed: Mar. 9, 2005

(30) Foreign Application Priority Data
Mar. 12, 2004 (JP) 2004-070815

(51) Int. Cl. G06F 17/60

(52) U.S. Cl. 705/14

(57) ABSTRACT

There is disclosed a sales management system in which customers can intuitively instantly recognize next exchangeable premium from existing accumulated points, and shops can save troubles and expenses for preparing signboards or fliers every time the premiums are changed. The sales management system includes a POS apparatus and a server. The server manageably has customer data which stores accumulated points for each customer ID, and premium data in which premium information and image are associated and stored for each present point range. The POS apparatus 1 has: a barcode scanner; a card reader for reading the customer ID; a control unit which adds up accumulated points of the customer data specified by the customer ID, and points imparted in accordance with a total amount of commodities and which extracts the premium information and image from the premium data based on the point range of the premium data specified by the addition; and a printer which prints the premium information and image on a receipt.

### BACKGROUND OF THE INVENTION

1. Field of the Invention

The present invention relates to a sales management system and method for a point service, and a program for the system, particularly to a process of a point of sales (POS) terminal device which displays information concerning the point service on its screen or prints it on a receipt for a customer.

2. Description of the Related Art

A sales management system having a function of performing a so-called point service has heretofore been known in which a point is imparted in accordance with a purchase money amount every commodity purchase in order to arouse customer interest. When a total point number reaches a preset service point number, a determined premium is exchanged every service points.

For example, in JP-A-1988-40994, a point of sales (POS) terminal device is described which prints, on a receipt, the number of points for receiving a service, for example, a message indicating “we will offer premiums, if you buy 20 points more” in a case where the total points do not reach the predetermined service points.

However, in the conventional technique, the number of the points required for the premium is only printed on the receipt. Therefore, the customer does not intuitively know a type of premium to actually obtain, and has to confirm concrete premium information or the premium with a signboard in a shop, a flier or the like. If the customer returns after shopping without seeing any signboard, flier or the like, the next exchangeable premium cannot be confirmed. If the premium information or image is seen by the signboard, flier or the like, it is disadvantageously time consuming to search for the exchangeable premium from the customer's existing total point number at the next commodity purchase time.

Moreover, the shop needs to prepare a large number of signboards or fliers indicating a list of premiums associated with points. In a case where the premiums are periodically changed, signboard or fliers are prepared every time, and replacement troubles and expenses have been required.

Furthermore, in a case where the premiums differ every points, the customer needs to search for the next premium to get from a plurality of premiums by the customer's existing total points, and there has been a problem that the next exchangeable premium is not easily seen.

As a countermeasure, it has been considered that a name of the next exchangeable premium is printed on the receipt or the like. Even in this case, there has been a problem that the customer needs to search for the premium based on the premium name, and does not easily intuitively see the premium.

### SUMMARY OF THE INVENTION

The present invention has been developed in consideration of the conventional situations, and an object is to provide a sales management system for a point service, in which a customer can intuitively instantly recognize the next exchangeable premium from existing accumulated points, and a store can reduce troubles and expenses for preparing signboards or fliers every time the premiums are changed.

To achieve the object, according to the present invention, there is provided a sales management system for a point service, which calculates a total amount of commodities bought by a customer and which imparts points for premium exchange in accordance with the total amount, the system comprising: customer data storage means for storing accumulated points for each customer ID; premium data storage means for associating premium information and premium image for each preset point ranges to store the premium information and premium image; customer ID input means for inputting the customer ID; control means for specifying the accumulated points of the customer data storage means based on the input customer ID, adding up the specified accumulated points and the points imparted in accordance with the total amount to calculate new accumulated points, specifying the point range of the premium data storage means based on the calculated new accumulated points, and extracting the premium information and premium image of the premium data storage means based on the specified point range; and premium data output means for outputting the extracted premium information and premium image in such a manner as capable of being recognized by the customer.

In the sales management system for the point service according to the present invention, the premium data output means preferably prints the premium information and premium image on a receipt to be handed over to the customer. The premium data output means may display the premium information and premium image on a display visible to the customer. Furthermore, a plurality of point range may be set, and the premium information and the premium image may differ with the plurality of set point ranges. The customer ID input means, control means, and premium data output means are preferably mounted on a POS apparatus, the premium data storage means may be mounted on a server apparatus connected to the POS apparatus via a communication network, and the customer data storage means may be mounted on the server apparatus, or a recording medium carried by the customer. Examples of the recording medium include mediums capable of holding the points, such as an IC card, a magnetic card, and a cellular phone.

To achieve the object, according to the present invention, there is provided a sales management method for a point service, which calculates a total amount of commodities bought by a customer and which imparts points for premium exchange in accordance with the total amount, said method comprising the steps of: storing accumulated points for each customer ID; associating premium information and premium image for each preset point ranges to store the premium information and premium image; inputting the customer ID; specifying the accumulated points based on the input customer ID; adding up the specified accumulated points and the points imparted in accordance with the total amount to calculate new accumulated points; specifying the point range based on the calculated new accumulated points; extracting the premium information and premium image based on the specified point range; and outputting the extracted premium information and premium image in such a manner as capable of being recognized by the customer.

In the sales management method for the point service according to the present invention, the step of outputting the extracted premium information and premium image preferably prints the premium information and premium image on a receipt to be handed over to the customer. The step of outputting the extracted premium information and premium image may display the premium information and premium image on a display visible to the customer. Furthermore, a plurality of point ranges may be set, and the premium information and premium image may differ with the plurality of set point ranges.

To achieve the object, according to the present invention, there is provided a program for enabling a computer to execute a sales management method for a point service, which calculates a total amount of commodities bought by a customer and which imparts points for premium exchange in accordance with the total amount, said method comprising the steps of: storing accumulated points for each customer ID; associating premium information and premium image for each preset point ranges to store the premium information and premium image; inputting the customer ID; specifying the accumulated points based on the input customer ID; adding up the specified accumulated points and the points imparted in accordance with the total amount to calculate new accumulated points; specifying the point range based on the calculated new accumulated points; extracting the premium information and premium image based on the specified point range; and outputting the extracted premium information and premium image in such a manner as capable of being recognized by the customer.

In the program according to the present invention, the step of outputting the extracted premium information and premium image preferably prints the premium information and premium image on a receipt to be handed over to the customer. The step of outputting the extracted premium information and premium image may display the premium information and premium image on a display visible to the customer. Furthermore, a plurality of point ranges may be set, and the premium information and premium image may differ with the plurality of set point ranges.

According to the present invention, there can be provided a sales management system and method for a point service, and control program, in which the customer can intuitively instantly recognize the next exchangeable premium from the existing accumulated points, whereas the store can reduce troubles and expenses for preparing signboards or fliers every time the premiums are changed.

### BRIEF DESCRIPTION OF THE DRAWINGS

In the accompanying drawings:

FIG. 1 is a schematic block diagram showing the whole constitution of a sales management system for a point service according to one embodiment of the present invention;

FIG. 2 is a schematic block diagram showing an inner constitution of a control unit of a POS apparatus;

FIG. 3 is a diagram showing a data structure of PLU data;

FIG. 4 is a diagram showing a data structure of customer data;

FIG. 5 is a diagram showing a data structure of premium data;

FIG. 6 is a schematic flowchart showing a process sequence of the sales management system; and

FIG. 7 is a diagram showing a printing example of a receipt.

### DESCRIPTION OF THE PREFERRED EMBODIMENT

Next, best modes for carrying out a sales management system for a point service, a sales management method, and a program according to the present invention will be described in detail with reference to the drawings.

The sales management system for the point service according to the present embodiment extracts premium information and premium image of premium data in a point range including accumulated points with respect to the accumulated points totaled and managed for each customer ID, when a customer performs a trade with a member card, a point card or the like. The system displays or prints the premium information and premium image together with accumulated points and points required for the next premium exchange in a display screen of the sales management system or on a receipt sheet issued from a printer of the sales management system.

Concretely, the sales management system for the point service comprises: a customer information management section which stores customer's accumulated points together with the customer ID; a premium information management section which stores the premium information and premium image associated for each point range; a display section which displays the premium information and premium image; and a printer section which issues the receipt on which the premium information and premium image are printed.

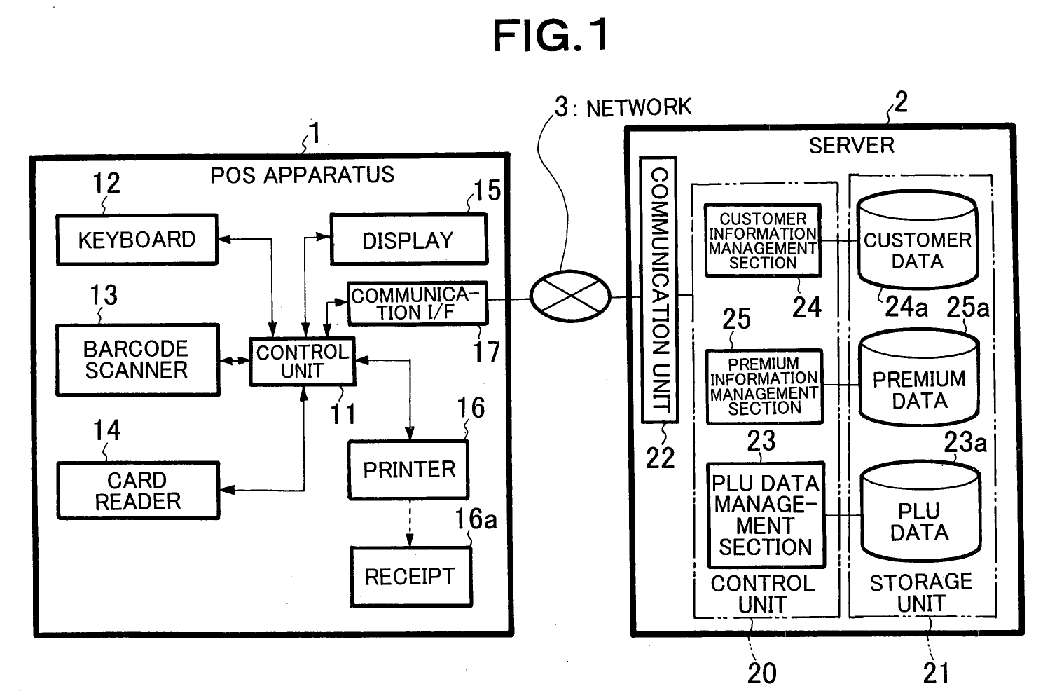

FIG. 1 is a constitution diagram of a sales management system for a point service according to one embodiment of the present invention. The sales management system shown in FIG. 1 comprises a POS apparatus 1 which is used in a trade with a customer whose utilizes a store and which is disposed on a checkout counter, and a server 2 which manages information such as price lookup (PLU) data 23a to be referred to by the POS apparatus 1. The POS apparatus 1 is mutually communicatably connected to the server 2 via a network 3. The network 3 comprises a communication circuit such as a local area network (LAN), wide area network (WAN) or the like, and a wired network and/or a wireless network can be applicable to it.

The POS apparatus 1 includes a control unit 11 such as a system controller or the like, which functions as a control center of the whole apparatus. As constituting elements connected to the control unit 11, the system includes: a keyboard 12 including various operation keys concerning trade with a customer; a barcode scanner 13 which optically reads a barcode attached to a package, a seal of a traded commodity or the like; a card reader (customer ID input means) 14 which reads customer information such as a customer ID from a customer card (e.g., a member card or a point card issued during member registration of the customer) carried by the customer and presented by the customer at a trading time; a display 15 which displays information on the trade with the customer in such a manner as to be visible to the customer, such as a cathode ray tube (CRT), a liquid crystal display (LCD) or the like; a printer 16 which prints the information on the trade with the customer on a receipt (receipt sheet) 16a for the customer; and a communication interface (I/F) 17 such as a LAN interface connected to the network 3. Since the existing elements are applicable to these constituting elements 12 to 17, details of the inner constitution are omitted in the present embodiment.

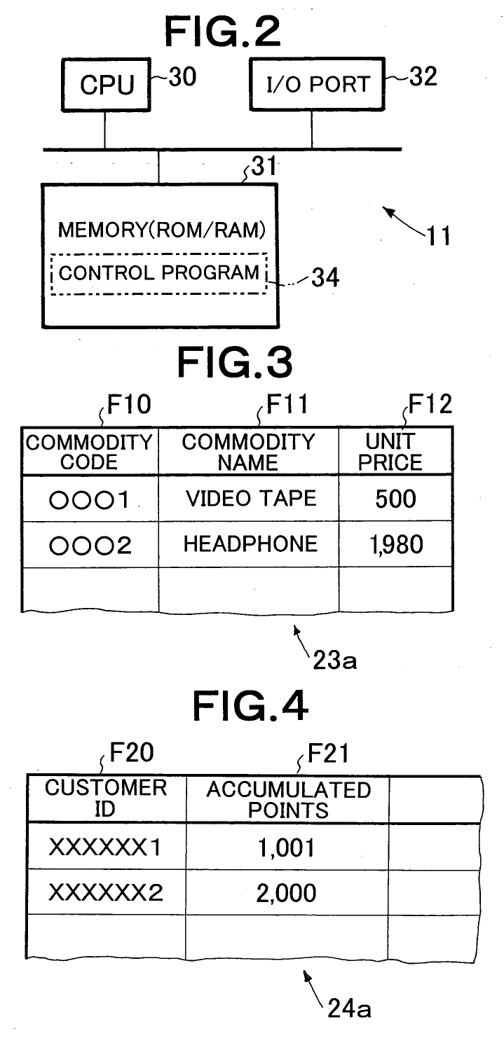

FIG. 2 shows an inner constitution example of the control unit 11. The control unit 11 shown in FIG. 2 includes a CPU (Central Processing Unit) 30, a memory (ROM (Read Only Memory) and/or RAM (Random Access Memory)) 31, and an I/O (Input/Output) port 32. The I/O port 32 is connected to the above-described constituting elements 12 to 17. A control program 34 executed by the CPU 30 is stored in the memory 31. By this constitution, the control unit 11 executes the control program 34 in the memory 31 to thereby perform processes (described later) concerning the point service in addition to a usual trade process while cooperating with operations of the constituting elements 12 to 17 in the POS apparatus 1 and the respective sections of the server 2.

The server 2 comprises a computer machine such as a PC (Personal Computer) server or the like, and functionally includes a control unit 20 having a CPU, a storage unit 21 of a memory (ROM/RAM) or a hard disk drive, and a communication unit 22 such as a LAN interface connected to the network 3.

Among these elements, in the storage unit 21, files (databases) of customer data 24a and premium data 25a are stored in addition to the PLU data 23a.

FIG. 3 shows a data structure example of the PLU data 23a. In the example of FIG. 3, a “commodity code” F10, “commodity name” F11, and “unit price” F12 are set as a plurality of fields constituting one record in the PLU data 23a, and the set data of each field is held in such a manner that the data can be updated, registered, or deleted as needed.

FIG. 4 shows a data structure example of the customer data 24a. In the example of FIG. 4, in the customer data 24a, as a plurality of fields constituting one record, a “customer ID” F20, “accumulated points” F21 and the like are set, and the set data of each field is held in such a manner that the data can be updated, registered, or deleted as needed.

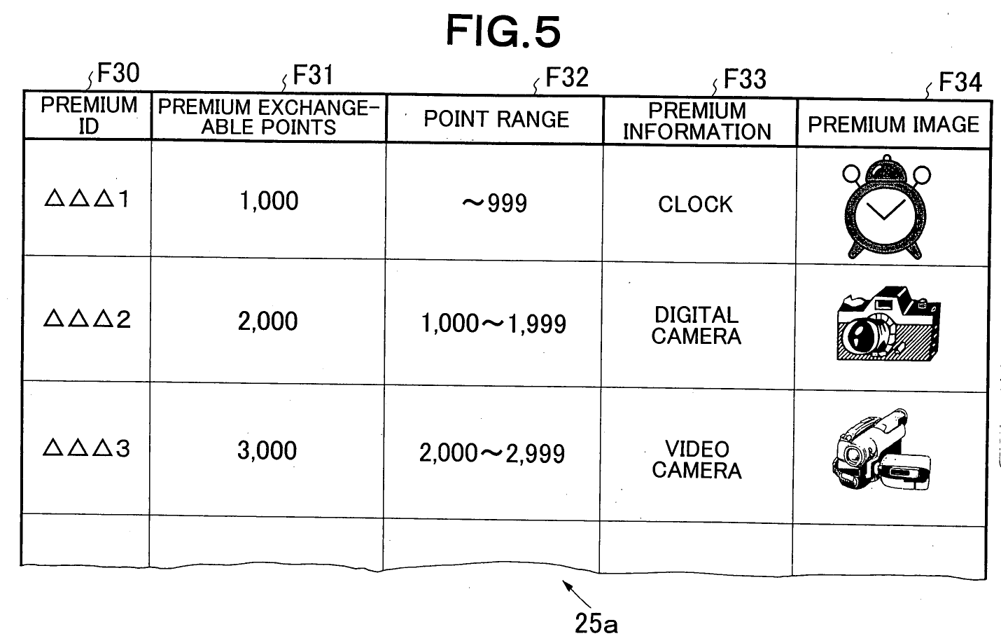

FIG. 5 shows a data structure of the premium data 25a. In an example of FIG. 5, in the premium data 25a, as a plurality of fields constituting one record, a “customer ID” F30, “premium exchangeable points” F31, “point range” F32, “premium information” F33, and “premium image” F34 are set, and the set data of each field is held in such a manner that the data can be updated, registered, or deleted as needed. In the example of FIG. 5, as the “premium information” F33 and the “premium image” F34, one premium is shown for each record, but the present invention is not limited to this, and a plurality of premiums may be set.

The control unit 20 functionally includes: a PLU data management section 23 which manages the PLU data 23a; a customer information management section (customer data storage means) 24 which manages the customer data 24a; and a premium information management section 25 which manages the premium information/image 25a. Functions of the respective management sections 23 to 25 are executed, when the CPU in the control unit 20 executes a control program (not shown) stored in the memory.

The PLU data management section 23 searches for the corresponding record from the PLU data 23a using a commodity code read by the barcode scanner 13 of the POS apparatus 1 as a key, and extracts the respective set data such as the “commodity name” F11 and the “unit price” F12 from the corresponding record so that the data can be transmitted to the POS apparatus 1.

The customer information management section 24 uses the customer ID read by the card reader 14 as a key, associates the key with the “customer ID” F20 of the customer data 24a to thereby store the data, adds up the points obtained by a total amount generated in the trade with the customer, and the set data of the “accumulated points” F21 of the record specified by the “accumulated points” F21, and updates an added value as new “accumulated points” F21.

The premium information management section 25 refers to the premium data 25a based on the customer's accumulated points obtained by the customer information management section 24, searches for the record of the “point range” F32 in which the accumulated points are included, and extracts the respective set data of the “premium exchangeable points” F31, “premium information” F33, and “premium image” F34 of the searched record so that the data can be transmitted to the POS apparatus 1.

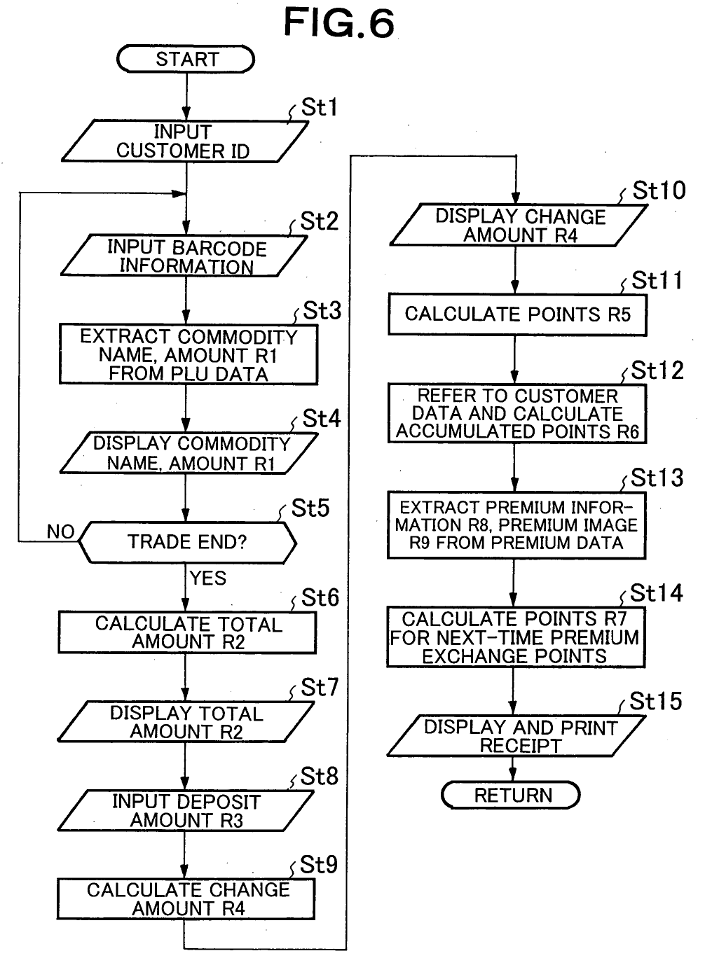

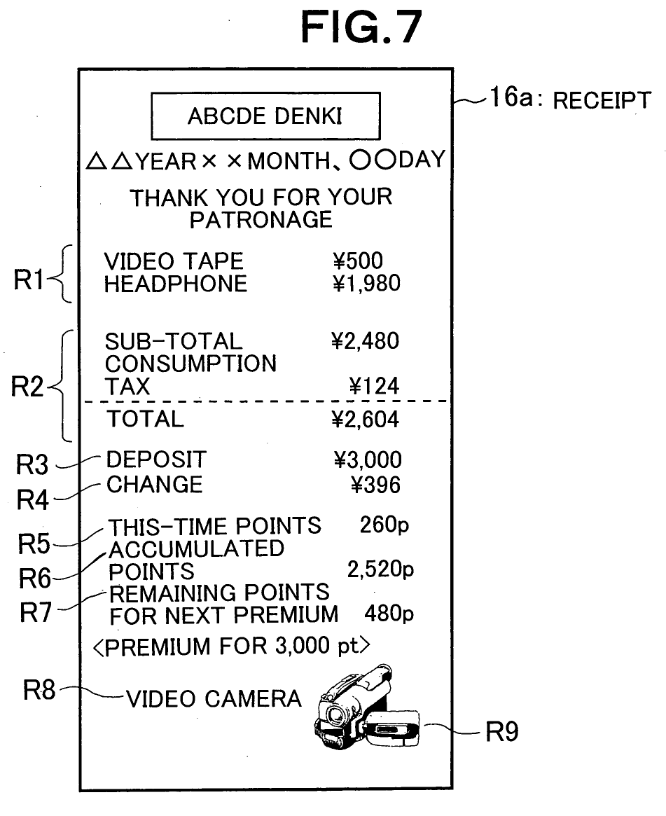

Next, a whole operation of the present embodiment will be described with reference to FIGS. 6 and 7.

FIG. 6 shows a process sequence of the sales management system. The process shown in FIG. 6 is performed, when the control unit 11 in the POS apparatus 1 cooperates with the control unit 20 (PLU data management section 23, customer information management section 24, and premium information management section 25) in the server 2, and the CPU 30 executes the control program 34 in the memory 31.

First, the control unit 11 allows the card reader 14 to read the customer card issued for each customer, and inputs the customer ID prior to the trade with the customer. Accordingly, data printed in the trade with the customer is associated with the customer data 24a through the customer information management section 24 in the server 2 based on the input customer ID.

Thereafter, the control unit 11 starts a usual trade process (steps St2 to St10). In starting the process, barcode information is input including a commodity code for each bought commodity input from the barcode scanner 13 every trade with the customer (step St2). The commodity code is used as a key, the corresponding commodity name and amount (unit price) (hereinafter referred to as “details” R1) are taken from the PLU data 23a in the server 2 (step St3), and the details R1 are displayed on the display 15 (step St4).

The process of the above-described St2 to St4 is repeatedly executed for each bought commodity until the trade with the customer ends (step St5). When the trade with the customer ends, the control unit 11 calculates a total amount (=sub-total+consumption tax) R2 of all bought commodities (step St6), and displays the total amount R2 (step St7).

Next, when a deposit amount R3 transferred from the customer is input from the keyboard 12 (step St8), a change amount R4 by a difference from the total amount R2 is calculated (step St9), and the change amount R4 is displayed on the display 15 (step St10).

When the above-described trade process ends, the control unit 11 starts a process (steps St11 to St15) concerning the point service. In starting the process, the control unit 11 calculates points R5 based on the total amount R2 calculated in the step St16 (step St11). The points R5 are calculated following a rule determined by a shop, for example, one point per a total amount of 10 yen of the bought commodity (discard fractions less than 10 yen).

Next, the control unit 11 adds the points R5 calculated as described above to the set data (accumulated points in the previous time) of the “accumulated points” F21 in the customer data 24a having the customer ID associated by the customer information management section 24 in the server 2, and obtains new accumulated points R6 (step Stl2).

Next, the control unit 11 searches for the “point range” F32 of the premium data 25a by the premium information management section 25 in the server 2 using the accumulated points R6 after the addition as a key. The unit specifies the set data of the “premium information” F33 and “premium image” F34 (hereinafter referred to as “premium information R8 and premium image R9”) from the record having the “point range” F32 including the accumulated points R6, and takes the data into the POS apparatus 1 (step St13). Moreover, a numeric value obtained by subtracting the accumulated points from premium exchangeable points is stored as points (remaining points R7) for the next premium exchange points in the POS apparatus 1 (step St14).

Next, the control unit 11 displays, on a screen of the display 15, the premium information R8 and premium image R9 taken into the POS apparatus 1 together with the details R1, total amount R2, deposit amount R3, change amount R4, this-time points R5, accumulated points R6, and remaining points R7 for the next premium in a predetermined display format. Moreover, the data is printed on a receipt 16a issued from the printer 16 in a predetermined printing format (step St15). A printed example of the receipt 16a is shown in FIG. 6.

The example of FIG. 7 shows a case where the total amount R2 of the commodity is 2,604 yen, the this-time points R5 are 260 points, and the accumulated points R6 are 2,520 points. In this case, the accumulated points R6 are printed on the receipt 16a. Since the “point range” F32 of the premium data 25a shown in FIG. 5 is included in 2,000 to 2,999, the next-time “premium exchangeable points” F31 correspond to 3,000. As the “premium information” F33 and the “premium image” F34, a video camera which can be exchanged when reaching 3,000 points, and the premium image are also printed together with 480 points (3,000−2,520) which are the remaining points R7 for the next premium. In this case, as to the remaining points R7, a message “this commodity can be obtained, when further 480 points are accumulated” may be displayed.

Therefore, according to the present embodiment, since the concrete premium information and premium image can be displayed, or printed on the receipt. Therefore, the shop does not require any premium information and premium image indication by signboards or fliers. In a case where many shops are owned, or premiums are periodically changed, costs can be reduced.

Moreover, according to the present embodiment, since the concrete premium information and premium image can be displayed, or printed on the receipt, the premium to obtain next can be intuitively displayed to the customer. A trouble for confirming the signboards, fliers or the like is saved, and accordingly customer interest can be further aroused.

It is to be noted that in the above-described embodiment, as customer data storage means and premium data storage means of the present invention, the constitution comprises the customer data 24a, premium data 25a, customer information management section 24, and premium information management section 25 in the server 2. However, some or all of these elements may be disposed in another computer or a processing unit, such as a server computer connected to a network in the POS apparatus 1.

Moreover, in the above-described embodiment, a case where in which the customer data 24a is stored in the server 2 has been described as the customer data storage means of the present invention. For example, in a case where storable mediums (recording mediums) such as an IC card and a magnetic card are used in the customer card, the accumulated points may be held directly in the card. In this case, the customer data 24a and customer information management section 24 in the server 2 can be omitted. The points may be held in a portable information terminal such as a cellular phone instead of the customer card.

Furthermore, in the above-described embodiment, an example has been described in which the process (steps St11 to St15) concerning the point service shown in FIG. 6 is executed after the step St10, but the process may be executed in any stage after the calculation of the total amount R2, that is, in and after the step St6.

1. A sales management system for a point service, which calculates a total amount of commodities bought by a customer and which imparts points for premium exchange in accordance with the total amount, said system comprising:
customer data storage means for storing accumulated points for each customer ID;
premium data storage means for associating premium information and premium image for each preset point ranges to store the premium information and premium image;
customer ID input means for inputting the customer ID;
control means for specifying the accumulated points of said customer data storage means based on the input customer ID, adding up the specified accumulated points and the points imparted in accordance with the total amount to calculate new accumulated points, specifying the point range of said premium data storage means based on the calculated new accumulated points, and extracting the premium information and premium image of said premium data storage means based on the specified point range; and
premium data output means for outputting the extracted premium information and premium image in such a manner as capable of being recognized by the customer.

2. The sales management system according to claim 1, wherein said premium data output means prints the premium information and premium image on a receipt to be handed over to the customer.

3. The sales management system according to claim 1, wherein said premium data output means displays the premium information and premium image on a display visible to the customer.

4. The sales management system according to any one of claims 1 to 3, wherein a plurality of point ranges are set, and the premium information and premium image differ with the plurality of set point ranges.

5. The sales management system according to any one of claims 1 to 3, wherein said customer ID input means, control means, and premium data output means are mounted on a POS apparatus.

6. The sales management system according to claim 5, wherein said premium data storage means is mounted on a server apparatus connected to said POS apparatus via a communication network.

7. The sales management system according to claim 5, wherein said customer data storage means is mounted on the server apparatus, or a recording medium carried by the customer.

8. A sales management method for a point service, which calculates a total amount of commodities bought by a customer and which imparts points for premium exchange in accordance with the total amount, said method comprising the steps of:
storing accumulated points for each customer ID;
associating premium information and premium image for each preset point ranges to store the premium information and premium image;
inputting the customer ID;
specifying the accumulated points based on the input customer ID;
adding up the specified accumulated points and the points imparted in accordance with the total amount to calculate new accumulated points;
specifying the point range based on the calculated new accumulated points;
extracting the premium information and premium image based on the specified point range; and
outputting the extracted premium information and premium image in such a manner as capable of being recognized by the customer.

9. The sales management method according to claim 8, wherein said step of outputting the extracted premium information and premium image prints the premium information and premium image on a receipt to be handed over to the customer.

10. The sales management method according to claim 8, wherein said step of outputting the extracted premium information and premium image displays the premium information and premium image on a display visible to the customer.

11. The sales management method according to any one of claims 8 to 10, wherein a plurality of point ranges are set, and the premium information and premium image differ with the plurality of set point ranges.

12. A program for enabling a computer to execute a sales management method for a point service, which calculates a total amount of commodities bought by a customer and which imparts points for premium exchange in accordance with the total amount, said method comprising the steps of:
storing accumulated points for each customer ID;
associating premium information and premium image for each preset point ranges to store the premium information and premium image;
inputting the customer ID;
specifying the accumulated points based on the input customer ID;
adding up the specified accumulated points and the points imparted in accordance with the total amount to calculate new accumulated points;
specifying the point range based on the calculated new accumulated points;
extracting the premium information and premium image based on the specified point range; and
outputting the extracted premium information and premium image in such a manner as capable of being recognized by the customer.

13. The program according to claim 12, wherein said step of outputting the extracted premium information and premium image prints the premium information and premium image on a receipt to be handed over to the customer.

14. The program according to claim 12, wherein said step of outputting the extracted premium information and premium image displays the premium information and premium image on a display visible to the customer.

15. The program according to any one of claims 12 to 14, wherein a plurality of point ranges are set, and the premium information and premium image differ with the plurality of set point ranges.

16. The sales management system according to claim 4, wherein said customer ID input means, control means, and premium data output means are mounted on a POS apparatus.
